(19) United States
(12) Patent Application Publication
(10) Pub. No.: US 2013/0114842 A1
(43) Pub. Date: May 9, 2013

(54) Ear Bud Adaptor

(71) Applicant: Kurt Jennings, Weehawken, NJ (US)

(72) Inventor: Kurt Jennings, Weehawken, NJ (US)

(21) Appl. No.: 13/291,221

(22) Filed: Nov. 8, 2011

(51) Int. Cl. H04R 1/10

(52) U.S. Cl. 381/380

(57) ABSTRACT

An adaptor for an ear bud headphone that adds an over-the-ear loop to enhance security of the placement of the ear bud headphones on the ear of the head phone user. An ear loop (that may or may not be adjustable in pivoting or up and down direction) is connected to a sheath receptacle that the ear bud snaps into. The contoured sheath is concave to follow the form of the ear bud. The ear bud wire passes through an open channel. The ear bud headphone securely held by the sheath. The tubular shaft, inherent in the ear bud design, is secured by fins that wrap around the tubular shaft.

### FIELD OF INVENTION

This invention relates generally to accessories for ear bud-style audio headphones and relates, more particularly, to an accessory to help secure ear bud-style headphones on the ear.

### BACKGROUND

Ear bud headphones commonly sold and distributed have a round speaker attached to a shaft, with a wire leading from the shaft toward the connection plug. Such ear bud headphones or “ear buds” do not stay in the ear as effectively as ear pieces which are inserted into the ear canal or other headphones that include additional features such as an over-the-ear loop. The looped ear bud headphones are commonly referred to as “sport headphones,” acknowledging their superiority for staying in the ear during athletic activity over the common simple ear bud headphones that do not have loops.

Certain audio players and cellular telephones are provided with ear bud headphones, as part of the standard equipment package. However, many users of these products find the ear bud headphones to be less effective, not because of sound quality, but because of an uncomfortable or unstable fit. As a result, the users purchase additional headphones to obtain a better fit, and do not use the ear bud headphones.

Therefore, it is an object of the present invention to provide an attachment to existing ear bud headphones that would enable users to use the ear buds and not have to purchase or obtain alternative headphones.

### SUMMARY OF THE INVENTION

The invention is an adaptor for an ear bud headphone that adds an over-the-ear loop to enhance security of the placement of the ear buds in the ear of the headphone user, especially during activity such as jogging and other sports. An ear loop is connected to a contoured and tapered sheath receptacle into which the ear bud is removably affixed. The contoured sheath is concave to follow the shape of the back of the ear bud, leaving the speaker to face the ear canal unobstructed. The ear bud wires pass through an open channel in the tapered portion of the sheath receptacle. In use, the ear bud is pressed down into the sheath, and the sheath holds the ear bud through a friction grip. The tubular shaft of the ear bud is secured by fins on the tapered portion of the sheath that wrap around both left and right sides of the shaft. The ear loop may be adjustable, allowing the user to rotate or pivot the ear bud for a more comfortable fit.

### BRIEF DESCRIPTION OF THE DRAWINGS

FIG. 1 is an outside view of a right hand embodiment of the invention, the left hand embodiment being a mirror image thereof.

FIG. 2 is an inside view of the embodiment shown in FIG. 1.

FIG. 3 is a rear end view of the embodiment shown in FIG. 1.

FIG. 4 is a top view of the embodiment shown in FIG. 1.

FIG. 5 is an inside view illustrating the insertion of an ear bud headphone into the invention.

FIG. 6 is an inside view illustrating the fixed position for the ear bud headphone after insertion into the invention.

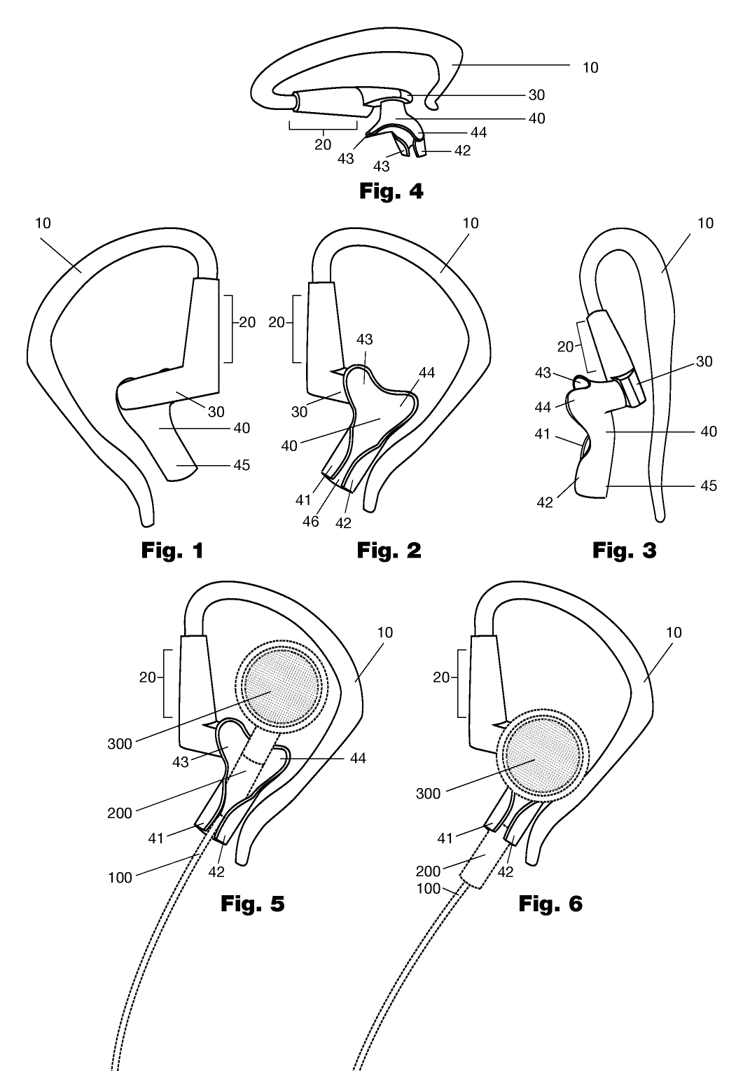

### DETAILED DESCRIPTION OF THE PREFERRED EMBODIMENT

The invention is comprised of tapered sheath 40, support arm 30, loop receptacle 20 and loop 10. Sheath 40, support arm 30 and loop receptacle 20 form a base unit and may be constructed as a single molded piece, or may be three separate elements attached together.

The sheath 40 is preferably made of a rigid material such as plastic or aluminum. The upper portion of sheath 40 is contoured to accommodate an ear bud, and includes two fins 43 and 44 which fins support and engage the contour of the rear side of ear bud headphone 300. A tapered shaft 45 is formed at the base of sheath 40, with flanges 41 and 42. Flanges 41 and 42 hold the tubular stem 200 of the headphone 300 in place. Preferably, flanges 41 and 42 form a channel into which tubular stem 200 may be supported by friction. A space 46 between flanges 41 and 42 provides easy access for the extending wire 100 of headphone 300.

Loop 10 is configured to fit around and over a user's ear, close to the side of the head. Preferably, loop 10 is made of a resilient material, so as to be flexible in positioning around the ear. Loop 10 may also be composed of different types of material, with a more flexible material used at the outer end, and a more rigid portion closer to the point of attachment with receptacle end 20.

FIGS. 5 and 6 illustrate how an ear bud headphone (100, 200, 300) locks into the ear bud accessory. Specifically, as shown in FIG. 5, the cord of the headphone (100) is placed into the space 46 between the flanges 41 and 42 of the tapered shaft 45. FIG. 6 shows the headphone (100, 200, 300) pushed down and into a secured position in the sheath 40. Flanges 41 and 42 grip the tubular stem 200, while the contoured upper portion of sheath 40 with fins 43 and 44 cradle the ear bud headphone (300).

Since ear bud headphones are symmetrical and formed for the left and right ears, the accessory will also have left and right units, which preferably will be mirror images of each other. The user will preferably place the right ear bud in the right ear bud accessory and the left ear bud in the left ear bud accessory.

The invention may be formed as one molded piece of material or as many be composed of three component materials. Where the invention would be manufactured with separate component pieces, loop 10 could be formed of a softer or more pliable material, and be inserted into a more rigid receptacle end 20 of the invention.

Loop 10 may incorporate a pivot or sliding feature to allow for rotational or vertical adjustments for additional comfort and fit for the user.

While certain novel features of the present invention have been shown and described, it will be understood that various omissions, substitutions and changes in the forms and details of the device illustrated and in its operation can be made by those skilled in the art without departing from the spirit of the invention.

I claim:

1. An accessory for ear bud style headphones, the ear bud headphone consisting of a speaker end, support shaft and audio wire, the accessory comprising:
a tapered sheath with two wings at an upper end, the sheath tapering to a channel at its lower end;
the channel of the sheath having an elongated opening along an interior side;
a support arm with a sheath end and a receptacle end attached at the sheath end to the sheath at its upper end; and
a loop attached to the receptacle end of the support arm,
where the sheath is contoured to be capable of receiving the speaker end of the ear bud, and where the channel of the sheath is capable of receiving the support shaft of the ear bud.

2. The accessory of claim 1, further comprising:
a loop receptacle attached at the receptacle end of the support arm, the loop receptacle capable of receiving an end of the loop and allowing the end of the loop to move while being supported by the loop receptacle.

3. The accessory of claim 1, the tapered sheath further comprising:
the upper end having a contoured interior side that matches a contour on a rear side of the speaker end of the ear bud headphone;
where the wings of the sheath extend to sides of the speaker end of the ear bud headphone;
and the upper end of the tapered sheath holds the speaker end of the ear bud headphone by friction.

4. An accessory for ear bud style headphones, the ear bud headphone consisting of a speaker end, support shaft and audio wire, the accessory comprising:
a tapered sheath with two wings at an upper end, the sheath tapering to a channel at its lower end, and a contoured area between the two wings with an interior side and an exterior side, the interior side of the contoured area capable of receiving the speaker end of the ear bud;
the channel of the sheath having an elongated opening along an interior side, the channel of the sheath capable of receiving the support shaft of the ear bud;
a support arm with a sheath end and a receptacle end attached at the sheath end to the rear side of the contoured area of the upper end of the sheath; and
a loop attached to the receptacle end of the support arm, the loop capable of extending over and around a user's ear.
